(19) United States
(12) Patent Application Publication
(10) Pub. No.: US 2015/0071720 A1
(43) Pub. Date: Mar. 12, 2015

(54) COMBINATION CUTTER AND TRANSMISSION SHAFT ASSEMBLY

(71) Applicant: SINO-ALLOY MACHINERY INC., Kuan-Yin estate (TW)

(72) Inventor: Mei-Chuan CHEN, Kuan-Yin estate (TW)

(73) Assignee: SINO-ALLOY MACHINERY INC., Kuan-Yin estate (TW)

(21) Appl. No.: 14/024,621

(22) Filed: Sep. 11, 2013

(51) Int. Cl. B26D 5/08

(52) U.S. Cl. CPC B26D 5/086
USPC 408/124

(57) ABSTRACT

A combination cutter and transmission shaft assembly used in a plastic pelletizing machine for cutting off an extruded plastic material from a perforated plate into plastic pellets is disclosed to include a transmission shaft rotatable on and axially movable along the axis thereof, and a cutter unit including a cylindrical cutter holder axially slidably coupled to and rotatable by the transmission shaft, a spring member mounted in the cylindrical cutter holder and stopped between one end of the transmission shaft and an inside wall of the cylindrical cutter holder and a plurality of cutter blades mounted at one end of the cylindrical cutter holder and kept in contact with the perforated plate and rotatable with the cylindrical cutter holder over the perforated plate.

### BACKGROUND OF THE INVENTION

1. Field of the Invention

The present invention relates to plastic pelletizing technology, and more particularly to a combination cutter and transmission shaft assembly used in a plastic pelletizing machine for making plastic pellets, which prevents perforated plate damage due to an overpressure.

2. Description of the Related Art

A plastic pelletizing machine for making plastic pellets is known using a motor to rotate a cutter over the surface of a perforated plate to cut off the extruded plastic material into plastic pellets. However, because the cutter is directly and rotatably abutted against the surface of the perforated plate without any buffer, the perforated plate will wear quickly with use.

### SUMMARY OF THE INVENTION

The present invention has been accomplished under the circumstances in view. It is the main object of the present invention to provide a combination cutter and transmission shaft assembly for plastic pelletizing machine, which prevents an overpressure damage during operation, prolonging the lifespan of the machine.

To achieve this and other objects of the present invention, a combination cutter and transmission shaft assembly of the invention comprises a transmission shaft and a cutter unit. The transmission shaft comprises a tubular shaft body rotatable on the axis thereof and axially movable forward and backward, and a plurality of axial coupling teeth located at a front end of said tubular shaft body. The cutter unit is coupled to and rotatable by the transmission shaft, comprising a cutter holder that comprises an accommodation hole axially defined in one end thereof for receiving the tubular shaft body of the transmission shaft and a plurality of axial coupling grooves axially slidably coupled to the axial coupling teeth of the tubular shaft body, a spring member mounted in the accommodation hole and stopped between an inside wall of the cutter holder and one end of the tubular shaft body of the transmission shaft, and a plurality of cutter blades fastened to one end of the cutter holder remote from the accommodation hole.

### BRIEF DESCRIPTION OF THE DRAWINGS

FIG. 1 is an oblique top elevational view of a part of a plastic pelletizing machine equipped with a combination cutter and transmission shaft assembly used in accordance with the present invention.

FIG. 2 is a side view of the plastic pelletizing machine shown in FIG. 1.

FIG. 3 is an elevational view of the combination cutter and transmission shaft assembly in accordance with the present invention.

FIG. 4 is a schematic sectional view illustrating the operation of the present invention (I).

FIG. 5 is a schematic sectional view illustrating the operation of the present invention (II).

FIG. 6 is a schematic sectional view illustrating the operation of the present invention (III).

### DETAILED DESCRIPTION OF THE PREFERRED EMBODIMENT

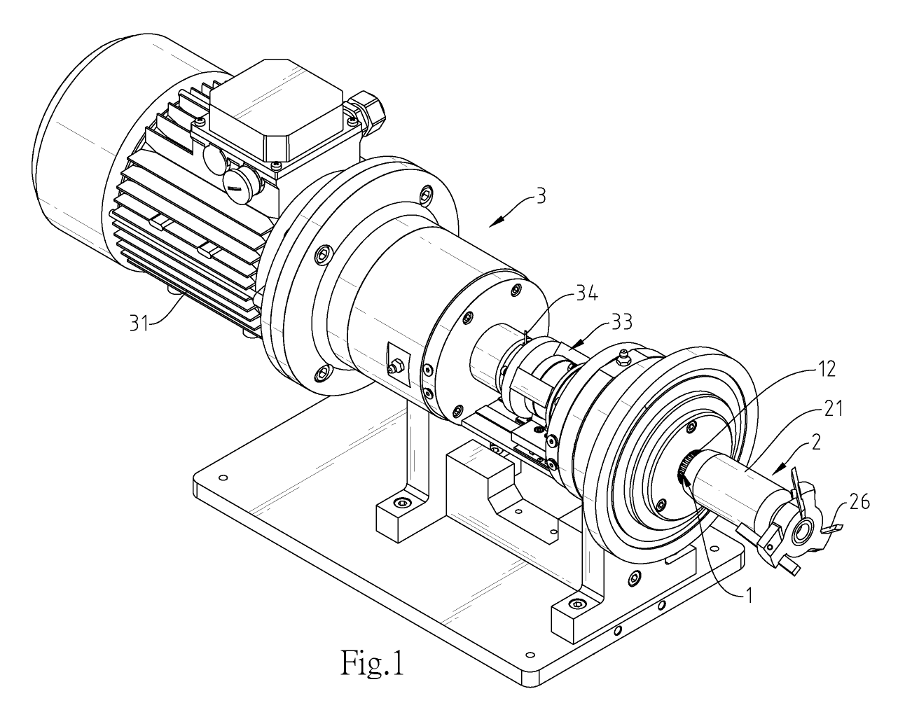

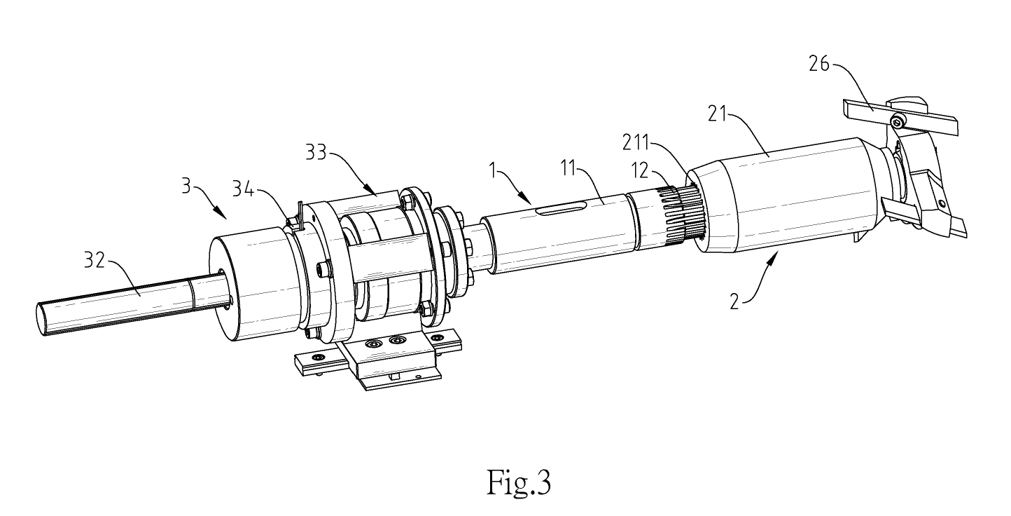

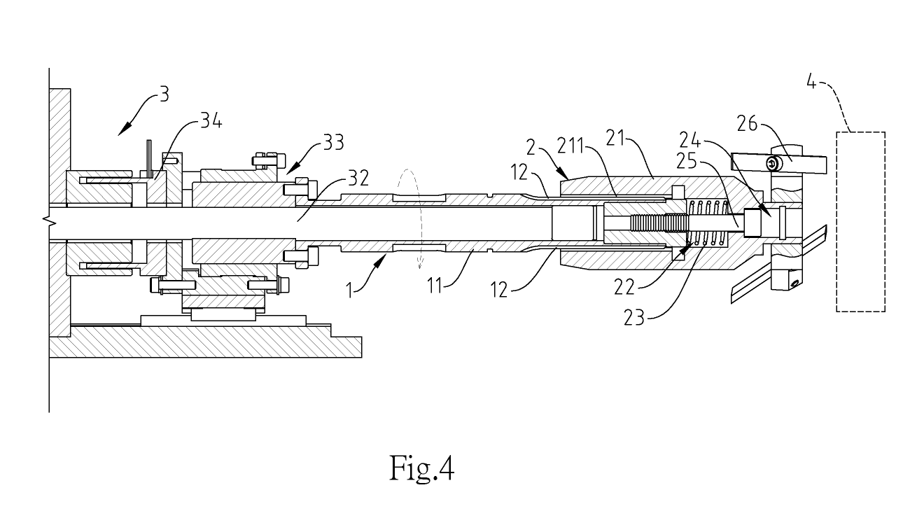

Referring to FIGS. 1-4, a combination cutter and transmission shaft assembly in accordance with the present invention is shown used in a plastic pelletizing machine and coupled to a driving mechanism 3. The combination cutter and transmission shaft assembly comprises a transmission shaft 1 and a cutter unit 2.

The transmission shaft 1 comprises a tubular shaft body 11 rotatable on the axis thereof and axially movable forward and backward, and a plurality of axial coupling teeth 12 equiangularly spaced around an outer perimeter of a front end of the tubular shaft body 11.

The cutter unit 2 comprises a cutter holder 21, a spring member 23, a locating member 25, and a plurality of cutter blades 26. The cutter holder 21 comprises an accommodation hole 22 axially disposed in one end thereof, a displacement hole 24 axially disposed in an opposite end thereof in communication with the accommodation hole 22, and a plurality of axial coupling grooves 211 equiangularly spaced around an inner perimeter thereof within the accommodation hole 22 and axially slidably coupled to the axial coupling teeth 12 of the tubular shaft body 11. The spring member 23 is mounted in the accommodation hole 22 and stopped with its one end against an inside wall of the cutter holder 21 between the accommodation hole 22 and the displacement hole 24 and its other end against the front end of the tubular shaft body 11. The locating member 25 is movably mounted in the displacement hole 24 and inserted through the spring member 23 into the tubular shaft body 11 of the transmission shaft 1 in the accommodation hole 22 and affixed to the tubular shaft body 11. The cutter blades 26 are affixed to one end of the locating member 25 outside the cutter holder 21 and rotatable and axially movable with the locating member 25.

The driving mechanism 3 comprises a main drive motor 31, a driving shaft 32, a bearing block 33, and a linear motor 34. The driving shaft 32 is coupled to and rotatable by the motor 31, and axially inserted through the tubular shaft body 11 of the transmission shaft 1. The bearing block 33 is affixed to one end of the tubular shaft body 11 of the transmission shaft 1 and mounted around and rotatable by the driving shaft 32. Thus, the driving shaft 32 can be driven by the main drive motor 31 to rotate the bearing block 33 and the tubular shaft body 11. The linear motor 34 is mounted at one side of the bearing block 33 and controllable to move the bearing block 33 and the tubular shaft body 11 axially forward and backward.

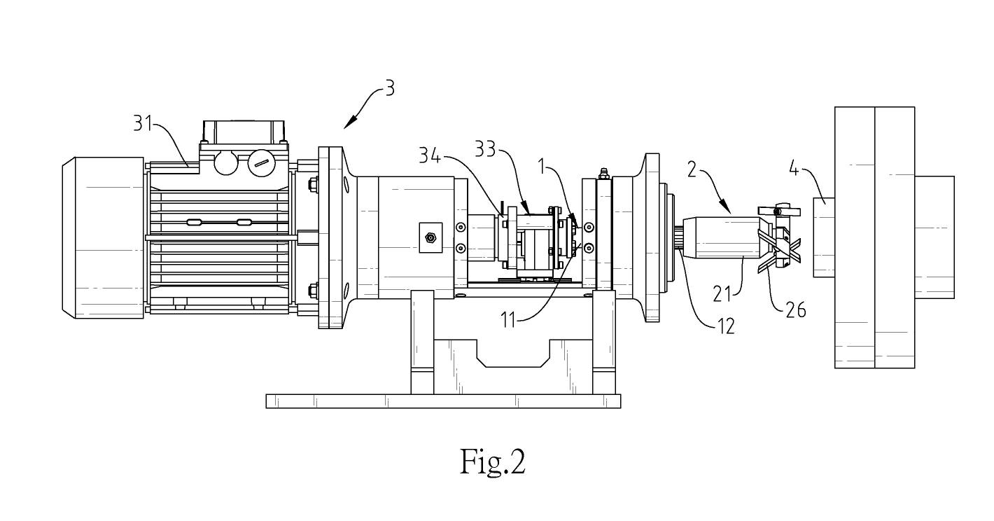

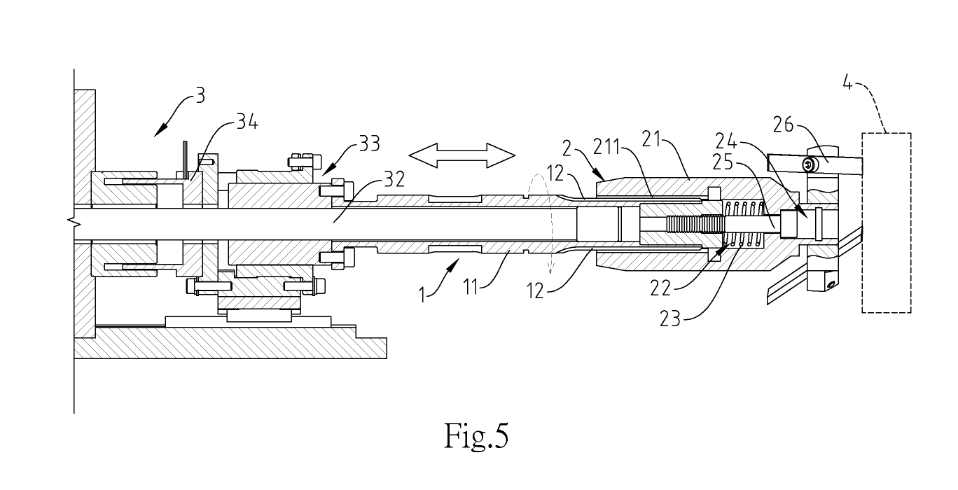

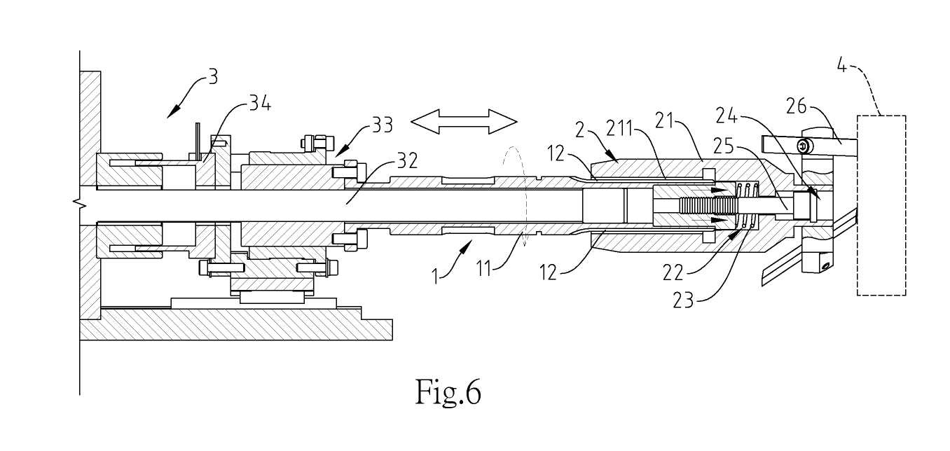

Referring to FIGS. 5 and 6 and FIGS. 2 and 4 again, during operation of the plastic pelletizing machine, the linear motor 34 is controlled to move the bearing block 33 and the tubular shaft body 11 axially forwardly toward a perforated plate 4 to push the spring member 23 against the cutter holder 21, forcing the cutter blades 26 of the cutter unit 2 into contact with the surface of the perforated plate 4. When continuously controlling the linear motor 34 to push the tubular shaft body 11 toward the perforated plate 4, the spring member 23 will be compressed to compensate the displacement of the tubular shaft body 11, preventing perforated plate damage due to an overpressure in the contact between the cutter blades 26 and the perforated plate 4. Further, subject to the functioning of the spring member 23 to compensate the displacement of the tubular shaft body 11, the cutter blades 26 are maintained in positive contact with the surface of the perforated plate 4.

What the invention claimed is:

1. A combination cutter and transmission shaft assembly, comprising:
a transmission shaft having a tubular shaft body rotatable on the axis thereof and axially movable forward and backward and a plurality of axial coupling teeth located at a front end of said tubular shaft body; and
a cutter unit coupled to and rotatable by said transmission shaft, said cutter unit comprising a cutter holder, said cutter holder comprising an accommodation hole axially defined in one end thereof for receiving said tubular shaft body of said transmission shaft and a plurality of axial coupling grooves axially slidably coupled to said axial coupling teeth of said tubular shaft body, a spring member mounted in said accommodation hole and stopped between an inside wall of said cutter holder and one end of said tubular shaft body of said transmission shaft, and a plurality of cutter blades fastened to one end of said cutter holder remote from said accommodation hole.

2. The combination cutter and transmission shaft assembly as claimed in claim 1, wherein said cutter holder further comprises a displacement hole axially defined in an opposite end thereof in communication with said accommodation hole; said cutter unit further comprises a locating member axially movably mounted in said displacement hole and rotatable with said cutter holder, said locating member having one end thereof suspending outside said cutter holder and mounted with said cutter blades and an opposite end thereof and axially inserted into said tubular shaft body of said transmission shaft.

3. The combination cutter and transmission shaft assembly as claimed in claim 1, wherein said axial coupling teeth of said transmission shaft are equiangularly spaced around the periphery of the front end of said tubular shaft body; said axial coupling grooves of said cutter holder are equiangularly spaced around an inner perimeter of said cutter holder within said accommodation hole.
